(19) United States
(12) Patent Application Publication
(10) Pub. No.: US 2008/0122882 A1
(43) Pub. Date: May 29, 2008

(54) Method for printing an article by using a UV ink-jet printer and a printing module for implementing the method

(75) Inventors: Chun-Yi Huang, Hsi Chih City (TW); Juiwen Cheng, Hsi Chih City (TW)

Correspondence Address: TROXELL LAW OFFICE PLLC, SUITE 1404, 5205 LEESBURG PIKE, FALLS CHURCH, VA, 22041, US

(73) Assignee: Great Computer Corporation.

(21) Appl. No.: 11/605,428

(22) Filed: Nov. 29, 2006

(51) Int. Cl. B41J 29/38

(52) U.S. Cl. 347/9

(57) ABSTRACT

A method for efficiently printing an article by using a UV ink-jet printer and a printing module for implementing the method are disclosed and characterized in that at least one of a color-ink and an assigned-color-ink printheads is connected with a movement-controlling mechanism which manages to move the printhead for a certain distance on the printing module. The article will be printed after the printhead is moved apart from its original location so that the article can be efficiently printed whether the color-ink or the white-ink printhead is to be utilized first.

### FIELD OF THE INVENTION

The present invention relates to a method for printing and, more particularly, to a method for efficiently printing an article by using a UV ink-jet printer wherein at least one of a color-ink and an assigned-color-ink printheads received in a printing module is moved apart from its original location before printing.

### BACKGROUND OF THE INVENTION

A printer is one of the important peripheral equipments of a computer. With the development of ink-jet technology, now some printers can produce colorful print by spraying droplets of differently colored ink. It is believed that the print produced so in no distant future may have a high quality similar to any color photo.

The ink-jet printer is more useful for producing small amount pieces of color print for it eliminates the necessity of making plural halftone plates.

As shown in FIG. 1, the arrangement of printheads B in a printing module A of a conventional type of a UV ink-jet printer is designed that a color and an assigned-color-ink printheads are disposed evenly. Such arrangement necessitates applying white ink to an article C before or after applying colored ink to the same. For example, in the case where white ink is to be applied firstly, the color-ink printhead B1 is not in use until a white strip has been printed in the article C, and then the assigned-color-ink printhead B2 is not in use as the other printhead B1 is spraying its ink to the same strip in the article C. That is to say, the printer works in a less efficient way.

Therefore, there is a need for an improved method for printing an article by using a UV ink-jet printer and a printing module for implementing the method in order to overcome the shortcomings of the prior art.

### SUMMARY OF THE INVENTION

It is an object of the present invention to provide a method for printing an article in an efficient way by using a UV ink-jet printer.

Another object of the present invention is to provide an improved printing module for implementing the aforementioned method.

To achieve the aforementioned objects, the present invention provides a method including the steps of connecting at least one of a color-ink and an assigned-color-ink printheads with a movement-controlling mechanism, and printing the article after the connected printhead is moved apart from its original location for a certain distance by the movement-controlling mechanism.

Other objects, advantages and novel features of this invention will become more apparent from the following detailed description when taken in conjunction with the accompanying drawings.

### BRIEF DESCRIPTION OF THE DRAWINGS

FIG. 1 is a schematic view illustrating how a conventional UV ink-jet printer operates;

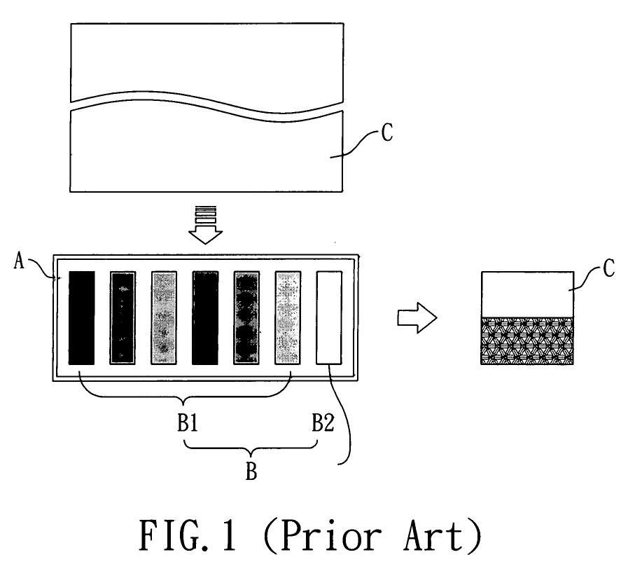

FIG. 2 is a flow chart of a method for printing an article by using a UV ink-jet printer according to the present invention;

FIG. 3 is a flow chart of a first embodiment of a method according to the present invention;

FIG. 4 is a schematic view of the first embodiment of the present invention showing a white-ink printhead moved forward;

FIG. 5 is a schematic view of the first embodiment of the present invention showing the white-ink printhead moved backward;

FIG. 6 is a flow chart of a second embodiment of a method according to the present invention;

FIG. 7 is a schematic view of the second embodiment of the present invention showing a white-ink printhead moved forward; and

FIG. 8 is a schematic view of the second embodiment of the present invention showing the color-ink printhead moved forward.

### DETAILED DESCRIPTION OF THE PREFERRED EMBODIMENT

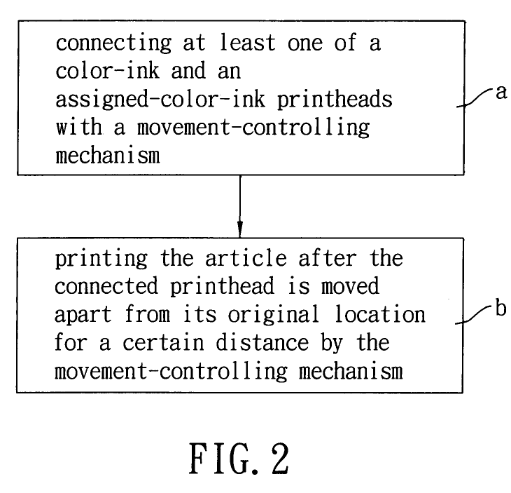

Referring to FIG. 2, a method in accordance with the present invention for efficiently printing an article by using a UV ink-jet printer includes the steps of:

a) connecting at least one of a color-ink and an assigned-color-ink printheads with a movement-controlling mechanism; and

b) printing the article after the connected printhead is moved apart from its original location for a certain distance by the movement-controlling mechanism.

The movement-controlling mechanism 1 performs in an electronic or a mechanical mechanism and is activated by a computer. The mechanisms used by the movement-controlling mechanism can be any conventional one that is adapted to achieve the purpose, such as those driven by a motor, a spring or electromagnetic induction, and so details about the movement-controlling mechanism 1 will not be described hereinafter.

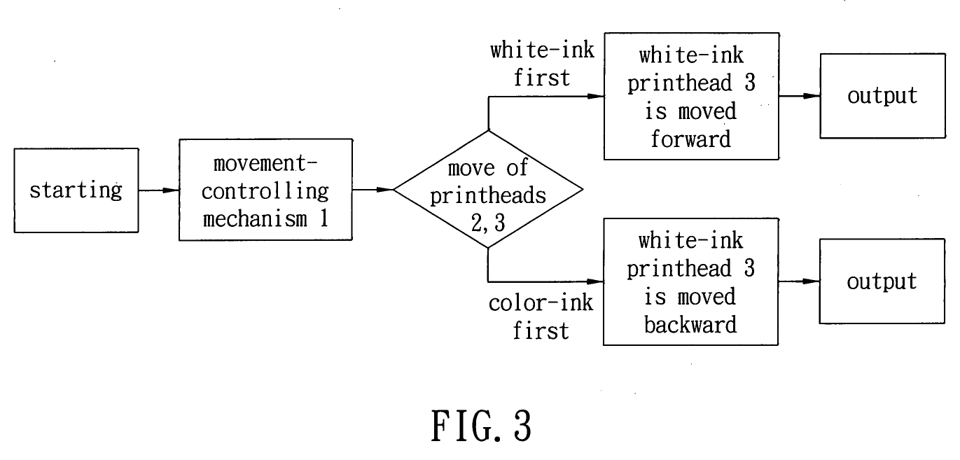

Referring to FIG. 3 to 5, these figures show a first embodiment of the present invention, wherein a color-ink 2 and an assigned-color-ink 3 printheads are received in a printing module 4. According to the different needs of different articles about whether color ink or assigned-color ink (the assigned-color ink can be white ink, transparent ink or others to meat the need and the white ink is taken as an example in the embodiment) is applied first, a printhead is moved by the movement-controlling mechanism 1 apart from its original location to print.

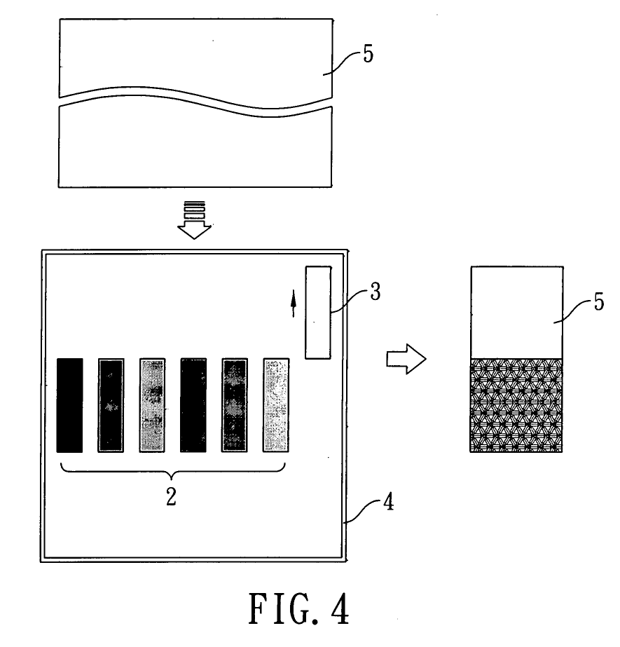

As shown in FIG. 4, the assigned-color-ink printhead 3 is moved forward, i.e. in a direction opposite to a direction in which an article 5 is desired to be advanced within the printer, for such a distance that the assigned-color-ink printhead 3 is disaligned from the colored-ink printhead 2 and it permits that the printer applies white ink to a strip in the article 5 first and applies color ink to the same strip after the article 5 is advanced by one more step.

In other words, the forward movement of the printhead 3 permits the printer to apply color ink to a strip in the article 5 while the printer is applying white ink to the next strip in the same media 5. This reduces the period of time necessary to be taken to print the whole media 5 and thereby provides the printer with an improved efficiency in its printing.

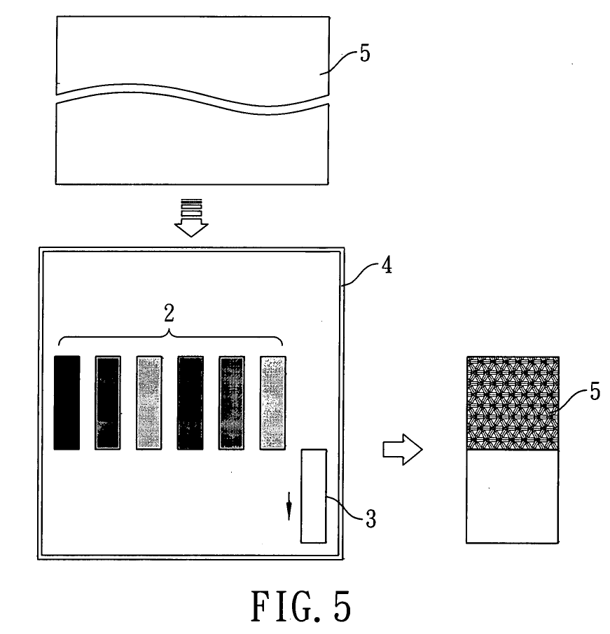

As shown in FIG. 5, the assigned-color-ink printhead 3 is moved backward, i.e. in a direction in which the article 5 is desired to be advanced within the printer, for such a distance that the assigned-color-ink printhead 3 is disaligned from the color-ink printhead 2 and it permits that the printer applies white ink to a strip in the article 5 first and applies color ink to the same strip after the article 5 is advanced by one more step.

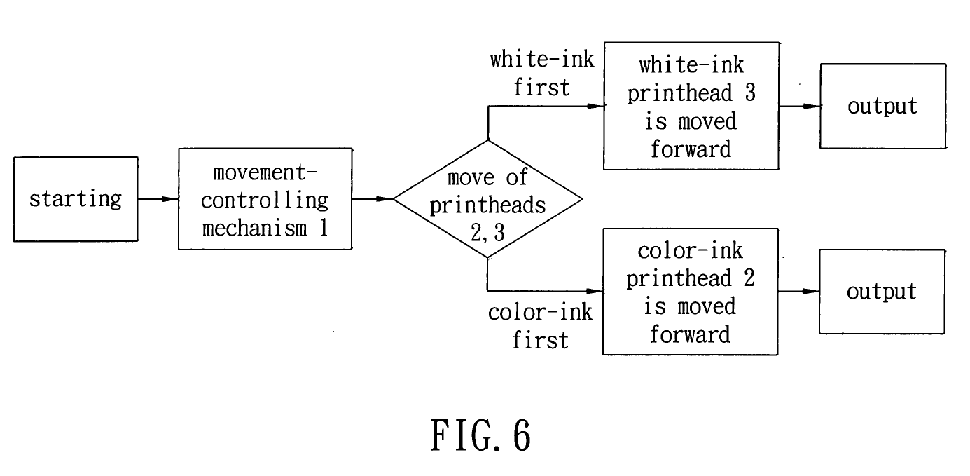

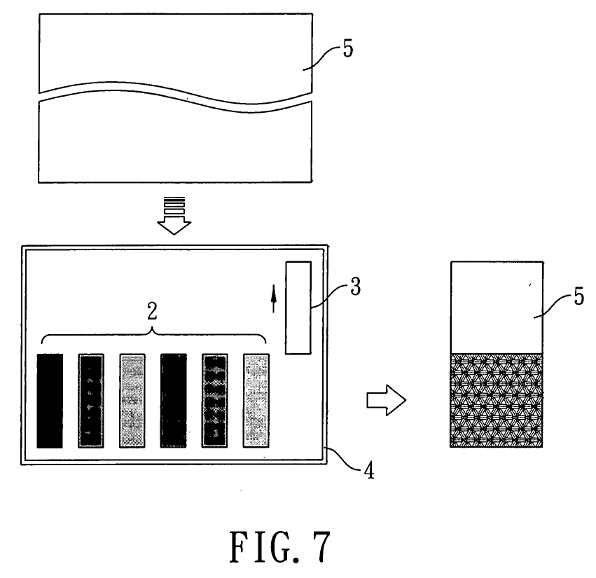

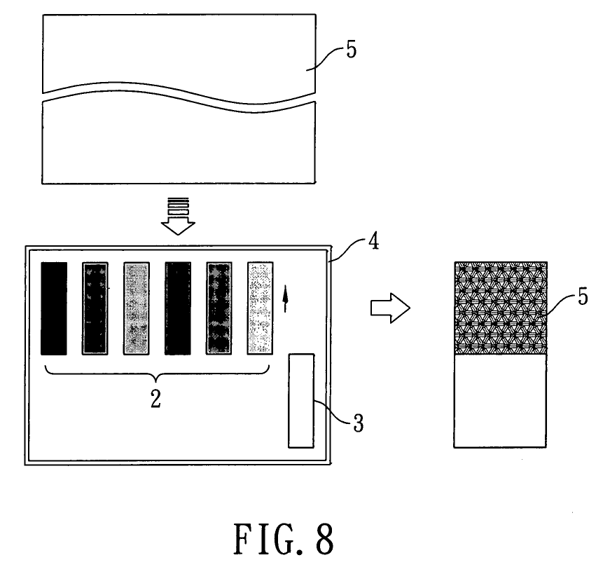

Referring to FIGS. 6 to 8, the color color-ink printhead 2 and the assigned-color-ink printhead 3 are connected with a movement-controlling mechanism land can be moved when the movement-controlling mechanism 1 is activated. For example, in the case where white ink is to be applied first, as shown in FIG. 7, the assigned-color-ink printhead is moved forward. And in the case where color-ink is to be applied first, as shown in FIG. 8, the color-ink printhead is moved forward. Besides, if required, the assigned-color-ink printhead and the color-ink printhead can be moved synchronously in opposite directions for a certain distance apart from their original locations so that the printing range is broadened greatly.

Obviously, the present invention provides the printing module 4 used in a UV ink-jet printer for receiving the color-ink 2 and assigned-color-ink 3 printheads wherein the two printheads can be moved thereon. At least one of the two printheads can be moved by the movement-controlling mechanism 1 apart from its original location for a certain distance before printing so that an efficient printing can be achieved whether color ink or white ink is to be applied first.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for printing an article by using a UV ink-jet printer, comprising steps of:
a) connecting at least one of a color-ink and an assigned-color-ink printheads with a movement-controlling mechanism; and
b) printing the article after the connected printhead is moved apart from its original location for a certain distance by the movement-controlling mechanism.

2. The method as claimed in claim 1, wherein the connected printhead is electronically or mechanically moved by the movement-controlling mechanism which is activated by a computer.

3. The method as claimed in claim 1, wherein each of the two printheads is connected with the movement-controlling mechanism, and the color-ink or the assigned-color-ink printhead can be moved apart from its original location by an activated movement-controlling mechanism.

4. The method as claimed in claim 1, wherein each of the two printheads is connected with the movement-controlling mechanism, and the two printhead can be moved simultaneously in opposite directions for a certain distance apart from their original locations by an activated movement-controlling mechanism.

5. The method as claimed in claim 1, wherein the two printheads are disposed within the printing module.

6. The method as claimed in claim 1, wherein assigned-color ink can be selected from the group of white ink, transparent ink, and others.

7. A printing module used in a UV ink-jet printer for receiving a color and an assigned-color-ink printheads thereon, characterized in that at least one of the two printheads is connected with a movement-controlling module which manages to move the connected printhead for a certain distance apart from its original location to print.

8. The printing module as claimed in claim 7, wherein the connected printhead is electronically or mechanically moved by the movement-controlling mechanism which is activated by a computer.

9. The printing module as claimed in claim 7, wherein each of the two printheads is connected with the movement-controlling mechanism, and the color-ink or the assigned-color-ink printhead can be moved apart from its original location by an activated movement-controlling mechanism.

10. The printing module as claimed in claim 7, wherein each of the two printheads is connected with the movement-controlling mechanism, and the two printhead can be moved simultaneously in opposite directions for a certain distance apart from their original locations by an activated movement-controlling mechanism.

11. The printing module as claimed in claim 7, wherein assigned-color ink can be selected from the group of white ink, transparent ink, and others.
